(19) United States
(12) Patent Application Publication
(10) Pub. No.: US 2026/0234351 A1
(43) Pub. Date: Aug. 13, 2026

(54) ANTIMICROBIAL POLYMER FOAMS COMPRISING A SYNERGISTIC BLEND OF COMPONENTS

(71) Applicant: Cupron Performance Additives, Inc., Richmond, VA (US)

(72) Inventors: Chenyu Wang, Midlothian, VA (US); Vikram Kanmukhla, Glen Allen, VA (US)

(73) Assignee: Cupron Performance Additives, Inc., Richmond, VA (US)

(21) Appl. No.: 19/155,128

(22) PCT Filed: Feb. 7, 2024
(86) PCT No.: PCT/US2024/014836

§ 371 Date: Aug. 8, 2025

Related U.S. Application Data
(60) Provisional application No. 63/444,107, filed on Feb. 8, 2023.
(60) Provisional application No. 63/614,030, filed on Dec. 22, 2023.
(60) Provisional application No. 63/614,048, filed on Dec. 22, 2023.
(60) Provisional application No. 63/614,080, filed on Dec. 22, 2023.
(60) Provisional application No. 63/614,089, filed on Dec. 22, 2023.
(60) Provisional application No. 63/621,127, filed on Jan. 16, 2024.

(51) Int. Cl. C08J 9/00; A01N 59/14; A01N 59/20; A01P 1/00; A01P 3/00

(52) U.S. Cl. CPC C08J 9/0066; A01N 59/14; A01N 59/20; A01P 1/00; A01P 3/00; C08G 2110/0041; C08J 2375/04

(57) ABSTRACT

Polymer foams, polyurethane foams, laminates, polymer coatings, or polyurethane coatings may comprise antimicrobial particles, flame-retardant articles, or combinations thereof. The antimicrobial polymer foams, laminates, polyurethane foams, polymer coatings, or polyurethane coatings may include a mixture of at least one antimicrobial metal compound and at least one synergistic compound. These articles may further include at least one pH adjuvant that creates an acidic environment within or exterior to the composition. It has been surprisingly found that these components create a synergistic relationship within a composition that provides a more tailored antimicrobial polymeric composition or article.

### FIELD OF THE INVENTION

Polymer foams, polyurethane foams, laminates, polymer coatings, or polyurethane coatings may comprise antimicrobial particles, flame-retardant articles, or combinations thereof. The antimicrobial polymer foams, laminates, polyurethane foams, polymer coatings, or polyurethane coatings may comprise a mixture of at least one antimicrobial metal compound and at least one synergistic compound. For example, in one embodiment, the antimicrobial polymer foams, polyurethane foams, polymer coatings, or polyurethane coatings may comprise at least one antimicrobial metal compound and a boric compound. The composition may further comprise at least one pH adjuvant that creates an acidic environment within the composition. It has been surprisingly found that these combination of components create a synergistic relationship within the composition that provides a more tailored antimicrobial foam for many applications.

Methods of producing antimicrobial polymer foams, polyurethane foams, polymer coatings, or polyurethane coatings may comprise adding particles that comprise at least one antimicrobial metal compound that releases antimicrobial ions upon contact with water such as, but not limited to, antimicrobial metal oxide, and at least one boric compound into a polymeric slurry or aqueous dispersion. The method may further comprise blending at least one pH adjuvant in a polymer slurry or aqueous dispersion to produce an antimicrobial product or article. The antimicrobial compound and/or boric compound may be added to the process as a powder, as a component in a masterbatch, or a combination of powders and masterbatch.

### BACKGROUND

Metal oxides or other antimicrobial metal compounds include, but are not limited to, copper oxide, copper iodides, copper carbonates, silver oxide, zinc oxide, silver chloride, zinc pyrithione, gold oxide, or combinations thereof. Such antimicrobial metal compounds have broad-spectrum antimicrobial properties and have demonstrated antifungal, antibacterial, and antiviral properties. Copper and its compounds can be found in articles, liquid coatings, and paints, plastic components, and polymeric material to impart durable and long-lasting antimicrobial activity to the different substrates.

There is a need for an antimicrobial, antiviral, and/or antifungal that is efficacious, processible, and has other advantageous properties for the production of antimicrobial compositions and articles.

### SUMMARY

Polymer foams are materials that consist of a polymer matrix with a significant volume of gas-filled cells dispersed throughout the polymer matrix. The polymer matrix is a solid phase surrounding the cells. This structure contributes to the material's lightweight and porous structure. These foams may be used in a wide variety of applications including, but not limited to, rigid foams, flexible foams, low density foams, thermally insulating foams, and cushioning.

The polymer matrix can be made from various types of polymers, including thermoplastics (polyethylene, polypropylene, for example), thermosetting plastics (polyurethane, epoxy, for example), and elastomers (rubber, for example). The choice of polymer and processing conditions is based upon the desired mechanical, thermal, and chemical properties of the resultant foam. Additionally, the cells may comprise an open or closed cell structure. These cell structures contribute to the foam density, flexibility, and insulation properties, for example.

Polymer foams include, but are not limited to, polyolefins foams, ethylene-vinyl acetate (EVA) foam (copolymers of ethylene and vinyl acetate, also referred to as polyethylene-vinyl acetate (PEVA)), low-density polyethylene (LDPE) foam, nitrile rubber (NBR) foam (copolymers of acrylonitrile (ACN) and butadiene), polychloroprene foam or neoprene, polyimide foam, polypropylene (PP) foam (including expanded polypropylene (EPP) and polypropylene paper (PPP)), polystyrene (PS) foam (including expanded polystyrene (EPS), extruded polystyrene foam (XPS), polystyrene (including extruded polystyrene), polyurethane (PU) foam (copolymers of isocyanates and polyols), low-resilience polyurethane or memory foam, polyurea foam, polyethylene foam, polypropylene foams, polyvinyl chloride (PVC) foam, closed-cell polyvinyl chloride foamboard, or silicone foam.

Antimicrobial, antiviral, and antifungal polymeric foams may be used for applications that may be exposed to bacteria, viruses, or fungi and/or for applications that have the environment to foster growth of the bacteria, viruses, or fungi. Embodiments of an antimicrobial, antiviral, or antifungal polymer foam may comprise a foamed polymer and a synergistic blend of an antimicrobial, antiviral, or antifungal particles embedded in the polymer. The synergistic blend of antimicrobial, antiviral, and antifungal particles include, but are not limited to, a plurality of particles comprising antimicrobial metal compound that release antimicrobial ions upon contact with a fluid in the polyurethane foam and a plurality of particles comprising boric compounds embedded in the polyurethane foam.

For example, an embodiment antimicrobial polyurethane foam may comprise a polyurethane foam having a plurality of particles comprising copper oxides or silver oxides that release antimicrobial ions upon contact with a fluid embedded in the polyurethane foam and a plurality of particles comprising boric compounds embedded in the polyurethane foam. Such an antimicrobial, antiviral, and/or antifungal polyurethane foam can kill these microbes upon contact, reduce the growth rate of these microbes, and/or kill these microbes over time. The particles comprising water insoluble antimicrobial metal compound that release antimicrobial ions upon contact with a fluid may be in any effective concentration that sufficiently controls the microbes in combination with the synergistic compounds and still allows formation of the desired foam product. For example, particles comprising water insoluble antimicrobial metal compound that release antimicrobial ions upon contact with a fluid may be in a concentration from 0.01 wt. % to 10 wt. % of the antimicrobial polyurethane foam.

Similarly, the particles comprising boric compounds may be in any effective concentration that sufficiently controls the microbes in combination with the water insoluble antimicrobial metal compound that release antimicrobial ions upon contact with a fluid and still allows formation of the desired foam product. For example, particles comprising boric compounds in a concentration from 0.05 wt. % to 15 wt. % of the antimicrobial polyurethane foam in combination with the water insoluble antimicrobial metal compound that release antimicrobial ions upon contact with a fluid.

The particle size of the particles comprising antimicrobial metal compounds and particles comprising the boric compounds may be of various sizes based upon the application and the structure of the polymer foam. In some embodiments, the particles comprising water insoluble antimicrobial metal compound that release antimicrobial ions upon contact with a fluid and/or the particles comprising the boric compounds are of a size of between 0.2 microns and 4 microns. In other embodiments, the particles comprising water insoluble antimicrobial metal compound that release antimicrobial ions upon contact with a fluid and/or the particles comprising the boric compounds are of a size of between 0.2 microns and 20 microns.

The water insoluble antimicrobial metal compounds that release antimicrobial ions upon contact with a fluid may be selected from, but are not limited to, copper oxide, copper iodides, copper carbonates, silver oxide, zinc oxide, zinc pyrithione, gold oxide, or combinations thereof.

Embodiments include, but are not limited to, antimicrobial polyurethane foams and articles. The antimicrobial polyurethane article may be a foam, fiber, coating, laminate, elastomer, or other article. An embodiment of the antimicrobial polyurethane article comprising a polyurethane and a blend of antimicrobial particles and synergistic particles, wherein at least a portion of the antimicrobial particles are modified to be hydrophobic.

Embodiments of the antimicrobial polyurethane article or foams may be derived from derived from the reaction of a polyol and an isocyanate. The isocyanate may be selected from the group including, but not limited to, methylene diphenyl diisocyanate, a toluene diisocyanate, and combinations thereof. In a certain embodiment, the hydrophobic methylene diphenyl diisocyanate is used with a hydrophobic particle such as, but not limited to, copper oxide coated with a hydrophobic coating.

Embodiments of antimicrobial polyurethane articles and polyurethane foam articles may be or included in personal hygiene containers (bed pans, cups, wash basins, trays), air handling equipment and components, air handling equipment and components, apparel (uniforms, outerwear, gloves, aprons, coats, sportswear, sleepwear, stockings, socks, hosiery, caps, undergarments, linings, shoes, headwear), appliances, automotive liners and surfaces, bath fixtures and components, bedding (blankets, mattresses, ticking, pads, sheets, pillow cases, fiberfill, pillows, sleeping bags), carpet and rug components and assembly, cleaning equipment (durable and disposable), cleaning supplies and tools, cloths and wipes, collection and storage container and equipment (including piping systems, silos, tanks, and processing vessels), conveyer belts, ear plugs, filters-gas and fluid, flooring materials and components, footwear and footwear components, furniture assemblies and components, furniture stuffing, gaskets, industrial equipment, insulation for wiring and cable, insulators and weather stripping, kitchen-bath hardware and fixtures, liners, mats (exercise, kitchen, bath), packaging material, plumbing supplies and fixtures, protective covers (durable and disposable), rain and sun barriers (awnings, umbrellas, vehicle covers), refuse containers (baskets, cans, bags), respirator components, sealants, sports clothing and equipment, synthetic leather, tape-medical, industrial, commercial, tarpaulins and covers, tools, tubing, hoses, pipes and piping components, vehicular components, water containers, for example, foams, mattresses, pillows, carpet padding, insulation, seat cushions, vehicle seats, wound dressings, kitchen sponges, sponges, packaging, footwear including insoles, laminates, fibers including, but not limited to, spandex fibers, and other articles. This method may be used to produce such articles. Further, the polyurethane article may be a polyurethane foam having a density greater than 2.0 lb./ft³ or, in some embodiment, the density of the foam is greater 3.0 lb./ft³.

Embodiments of the articles comprising the antimicrobial coating or laminates include, but are not limited to, air handling equipment and components, air handling equipment and components, apparel (uniforms, outerwear, gloves, aprons, coats, sportswear, sleepwear, stockings, socks, hosiery, caps, undergarments, linings, shoes, headwear), automotive liners and surfaces, bags (including garment, garbage, bedding, vacuum), barrier fabric, bath fixtures and components, bedding (blankets, mattresses, ticking, pads, sheets, pillow cases, fiberfill, pillows, sleeping bags), building materials and components (residential and commercial siding, for example), carpet and rug components and assembly, cleaning supplies and tools, cloths and wipes, collection and storage container and equipment (including piping systems, silos, tanks, and processing vessels), industrial equipment, insulation for wiring and cable, kitchen-bath hardware and fixtures, liners, mats (exercise, kitchen, bath), packaging material, plumbing supplies and fixtures, rain and sun barriers (awnings, umbrellas, vehicle covers), refuse containers (baskets, cans, bags), respirator components, sealants, sports clothing and equipment, synthetic leather, tape-medical, industrial, commercial, tarpaulins and covers, tools, tubing, hoses, pipes and piping components, and water containers, for example.

Polymer foams may be produced by any method known in the polymerization and foaming arts. The components may be added in any order that results in proper polymerization of the monomers, oligomers, or cross-linking polymers. For example, an embodiment of the method of making a polyurethane foam with antibacterial, antifungal and/or antiviral properties comprises adding particles comprising an antimicrobial metal compound and particles comprising a boric compound to at least one of an isocyanate and a polyol to form a polyurethane foam precursor. The particles may be added to either raw material or both raw materials. For example, the process may comprise blending the polyurethane foam precursor with the other of the isocyanate and the polyol and providing polymerization conditions for production of polyurethane foam. The polyurethane may be blown to a foam. The blowing agent may be carbon dioxide or other known blowing agents. The foam may be formed or cut to produce the desired articles.

The properties of the components may be modified to affect the final products of the article. For example, the particles may be coated prior to use in the process. The particles may be coated with at least one of a hydrophilic coating, a hydrophobic coating, a coating of one or more of the monomers, or another coating that improves the processing or final chemical or physical properties of the antimicrobial, antiviral, or antifungal polymer foam. For example, if the isocyanate monomer is hydrophobic, the particles comprising water insoluble antimicrobial metal compound that release antimicrobial ions upon contact with a fluid and/or the particles comprising the boric compounds may comprise a hydrophobic coating to improve solubility. Similarly, if the isocyanate monomer is hydrophilic, the particles comprising water insoluble antimicrobial metal compound that release antimicrobial ions upon contact with a fluid and/or the particles comprising the boric compounds may comprise a hydrophilic coating to improve solubility. Therefore, the process may comprise treating a plurality of particles comprising an antimicrobial metal compound that release antimicrobial ions upon contact with a fluid to produce a plurality of hydrophobic antimicrobial particles and/or treating a plurality of particles comprising boric compounds to produce a plurality of hydrophobic synergistic compounds. These particles may then be mixed with a polyol, particles comprising boric compounds, and the plurality of hydrophobic antimicrobial particles to form a polyol slurry or mixed with the isocyanate to form an isocyanate slurry. The polymerization reaction mixture is then completed, and process conditions are set.

In another embodiment, if the isocyanate monomer is hydrophobic, the particles comprising water insoluble antimicrobial metal compound that release antimicrobial ions upon contact with a fluid and/or the particles comprising the boric compounds may comprise a hydrophilic coating. The inventors have found that a particle with such coatings is forced to the exterior surface of the foam structure and are more available for antimicrobial efficacy. Similarly, if the isocyanate monomer is hydrophilic, the particles comprising water insoluble antimicrobial metal compound that release antimicrobial ions upon contact with a fluid and/or the particles comprising the boric compounds may comprise a hydrophobic coating.

The surface modification particles may be produced by any method known in the art. For example, antimicrobial particles may be surface modified by a reaction with a fatty acid, for example. The particles may be surfaced modified with a stearic acid, a fatty acid comprising a hydrophobic tail, an oleic acid, a palm oil, a saturated fatty acid or combinations thereof, for example.

Additional processing or chemical or physical property modifying agents may also be added to the reaction mixture. The method may comprise mixing at least one of a polymeric thickener and a surfactant with the polyol or isocyanate and particles.

Further embodiments include antimicrobial polyurethane article, foam, laminate, or coating comprising a polyurethane substrate, a plurality of particles comprising at least one boric compound embedded in the polyurethane substrate, and a plurality of copper oxide particles embedded in the polyurethane substrate. The copper oxide particles may have a hydrophobic coating on their surface.

Embodiment of the polymeric foam may comprise a polymer foam, particles comprising water insoluble antimicrobial metal compound that release antimicrobial ions upon contact with a fluid embedded in the polymer foam and particles comprising boric compounds embedded in the polymer foam.

The water-insoluble antimicrobial metal particles that release antimicrobial metal ions at a certain rate and produce some antimicrobial efficacy upon contact with a fluid, for example. Therefore, these antimicrobial masterbatches and powder blends are used in processes to produce antimicrobial products, foams including polyurethane foam, laminate, coating, or other articles. The degree of antimicrobial efficacy may be a function of the antimicrobial agent, its concentration in the article or composition, the environment that the antimicrobial article experiences, the physical and mechanical properties of the article, the inert ingredients in the article, and other factors. There may be a need or desire to modify this inherent antimicrobial efficacy, inherent antimicrobial durability, or the concentration of the antimicrobial compounds necessary to provide the desired antimicrobial efficacy and/or antimicrobial durability in some applications of the foam, coating, composition or article. A synergistic blend of particles comprising water-insoluble antimicrobial metal, particles comprising the boric compounds, and a pH adjuvant, can modify the release rate and efficacy of the antimicrobial article by providing a combination of antimicrobial metal ions, controlling the pH on the surface of the polymer when in contact with water, producing additional antimicrobial agents, and/or other chemical or mechanical modifications to the article or foam.

In an embodiment, the antimicrobial metal compound is copper oxide. The water-insoluble copper oxide particles release at least one of Cu+ ions and Cu++ ions upon contact with a fluid and are embedded in the polymer, wherein a portion of the particles comprising the water-insoluble copper oxides are exposed and protruding from surfaces of the polymeric material. In such embodiments, the water insoluble copper compound may be in a concentration from 0.01 wt. % to 10 wt. % of the antimicrobial article or composition. The water insoluble antimicrobial metal compound may include, but are not limited to, copper oxide, copper chlorides, cuprous oxide, cupric oxide, copper iodides, copper carbonates, silver oxide, silver iodide, silver chlorides, zinc oxide, zinc chlorides, zinc pyrithione, gold oxide, or combinations thereof, for example. In another embodiment more advantageous for certain applications, copper oxide or other antimicrobial metal compounds may be in a concentration from 0.01 wt. % to 2 wt. % of the weight of the article or composition.

Embodiments of a masterbatch and powder blends may also comprise particles comprising at least one boric compound. The at least one boric compound include, but are not limited to, metal borates, boric salts, boric acid, sodium borate, a compound that produces an antimicrobial metal ion and boric acid on contact with water, sodium borate, potassium borate, zinc borate, and combinations thereof. The masterbatch, powder, or combination of the masterbatch and powder may be used to produce the polyurethane foam, laminate, coating, or other articles.

The synergistic blend may also comprise particles comprising a pH adjuvant. The pH adjuvant may be in a concentration from 0.01 wt. % to 5.0 wt. % or, in a more specific embodiment, the pH adjuvant is in a concentration from 0.1 wt. % to 3 wt. %. In certain embodiments, the solid pH adjuvant particle is molybdenum oxide.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of components, parts, techniques and steps are disclosed. Each of these has individual benefits and each can also be used in conjunction with one or more, or in some cases, all of the other disclosed embodiments and techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### BRIEF DESCRIPTION OF THE FIGURES

FIG. 1 shows the effectiveness of polyester fabric samples comprising particles of copper oxide and particles of zinc borate versus untreated polyester fabric samples in preventing AN growth on the surface of the fabric samples; untreated PET fabric control before (A1) and after (B1) 4-week incubation; Sample #4 before (A2) and after (B2) 4-week incubation; Sample #7 before (A3) and after (B3) 4-week incubation; Sample #8 before (A4) and after (B4) 4-week incubation; Sample #10 before (A5) and after (B5) 4-week incubation; Sample #11 before (A6) and after (B6) 4-week incubation; Sample #12 before (A7) and after (B7) 4-week incubation;

FIG. 2 shows the effectiveness of polyester fabric samples comprising particles of copper oxide and particles of zinc borate versus untreated polyester fabric samples in preventing AN growth on the surfaces after 1-week incubation in SDB at 22° C.; and

FIG. 3 shows the color stability comparing the prior art PET fabric sample containing (left) 1% copper oxide and (right) an embodiment of the PET fabric sample comprising 0.6% copper oxide, 0.6% zinc borate and 0.3% molybdenum oxide after being exposed to 10% H2O2 solution.

### DESCRIPTION

Antimicrobial polyurethane foam, laminate, coating, or other articles may be made from adding antimicrobial agents into the reaction mixture prior to the reaction or polymerization. Typically, the antimicrobial agent is added to the reaction or polymerization mixture as a powder or a masterbatch. A masterbatch is typically a polymer with an antimicrobial agent blended into the polymer. The polymer may be a thermoplastic polymer so the polymer may be remelted to release the antimicrobial agent into the new substrate.

In some embodiments of the polymer foam, laminate, coating, or other articles, at least a portion of the particles comprising antimicrobial metal compounds are exposed and protrude from the surface of the polymeric masterbatch. The antimicrobial metal compounds include, but are not limited to, copper oxide, copper iodides, copper carbonates, silver oxide, zinc oxide, zinc pyrithione, gold oxide, or combinations thereof. The particles comprising an antimicrobial metal compound may be characterized by an average particle size between 0.2 microns and 10 microns. In a specific embodiment of the masterbatch or powder, the antimicrobial compound is copper oxide. In another specific embodiment of the masterbatch or powder, the antimicrobial compound is silver oxide.

In some further embodiments, the particles may comprise additional components. The additional components may comprise additional antimicrobial compounds, compounds that interact with the antimicrobial compounds to increase or decrease their efficacy or duration, compounds that react with other components to form antimicrobial compounds or form more efficacious antimicrobial compounds, or other synergistic compounds. For example, a foam, coating, or other article may comprise a pH adjuvant. The pH adjuvant may be in the polyurethane foam, laminate, coating, or other articles with other components such as the particles comprising antimicrobial compounds or the particles comprising the boric compound or the masterbatch may consist essentially of a pH adjuvant. Such a foam or coating may comprise any of the additional compounds, as desired.

The pH adjuvant may be, but is not limited to, one of a compound that produces an acidic environment on contact with water, acidic oxide, acidic salt, molybdenum oxide, chromium oxide, chromium chloride, molybdenum chloride, and combinations thereof, for example. The particles comprising the pH adjuvant are characterized by an average particle size between 0.2 microns and 10 microns.

The particles of water insoluble antimicrobial metal compounds that release antimicrobial ions upon contact with a fluid and particles comprising boric compounds are particles comprising both water insoluble antimicrobial metal compound that release antimicrobial ions upon contact with a fluid and boric acid or a compound that produces boric acid upon contact with water. The polymeric reaction slurry may further comprise a pH adjuvant.

In processes to produce antimicrobial polymer foam, laminate, coating, or other articles, the particles comprising antimicrobial metal compounds and particles comprising boric compounds may be added to the process in one or more masterbatch, one or more powders, or combinations of masterbatch and powders. An embodiment of a blend of an antimicrobial powder comprising at least one particle comprising water insoluble antimicrobial metal compound that releases antimicrobial ions upon contact with a fluid and particles comprising boric compounds. The blend of antimicrobial powder may comprise synergistic blend of particles. The blend may comprise any combination of particles that are effective at producing antimicrobial efficacy in a final article. For example, an embodiment of the blend of antimicrobial powder may comprise a weight ratio of particles comprising water insoluble antimicrobial compounds to particles comprising boric compounds is between 1:0.2 and 1:10. The particles of the antimicrobial powder are characterized by an average particle size between 0.2 microns and 10 microns. The blend of antimicrobial powder may comprise a pH adjuvant.

For example, an embodiment of the synergistic polymeric composition may comprise a reaction monomers such as, but not limited to polyols and isocyanates, a plurality of copper compounds that release copper ions in the presence of water, zinc borate, and molybdenum oxide.

A highly effective antimicrobial composition comprises at least one antimicrobial metal compound and at least one boric compound such as a metal borate (hereinafter “synergistic antimicrobial composition”). It was surprisingly discovered that even though zinc borate has no significant inherent antimicrobial activity. In some embodiments, the antimicrobial efficacy of the synergistic antimicrobial composition is found to be greater than sum of its component's individual efficacy, though the synergistic compounds may improve other properties other than efficacy.

### Proposed Theoretical Mechanism

Embodiments of the invention comprise a synergistic blend of compounds that produce an improved antimicrobial efficacy, improved color stability, improved processibility, or improve other properties to a polyurethane foam, laminate, coating, or other articles. An embodiment of an antimicrobial polymeric composition comprises synergistic blend of components, wherein the synergistic blend of components includes at least one antimicrobial metal compound, that, for example, increases the antimicrobial efficacy of the polymeric composition above the antimicrobial efficacy of a polymeric composition consisting essentially of the individual components alone. The individual antimicrobial efficacy of an individual antimicrobial compound and the antimicrobial efficacy of the synergistic combination of a blend comprising the individual antimicrobial compound and a potentially synergistic compounds may be measured by determining and comparing or the zone of inhibition of the individual antimicrobial compounds and the blend in the polymeric composition. The improvement in other properties may be similarly measured and compared.

The synergistic polymeric composition comprises a polymer, particles comprising a plurality of antimicrobial metal compounds embedded in the polymer and particles comprising a boric compound. The synergistic polymeric composition may comprise a metal borate and copper oxides, for example.

For example, an embodiment of the synergistic polymeric composition may comprise a polymer, a plurality of copper compounds that release copper ions in the presence of water and particles comprising zinc borate. Though not wishing to be limited by a disclosed mechanism, in such an embodiment, it is theorized that though the zinc borate (ZnB3O4(OH)3) is only sparingly incongruent soluble in water at room temperature and may reversibly hydrolyze to insoluble Zn(OH)2 and soluble H3BO3, a weak acid.

One of the synergistic compounds may dissolve incongruently. Many substances dissolve congruently (the composition of the solid and the dissolved solute stoichiometrically match). However, some substances may dissolve incongruently, whereby the composition of the solute in solution does not match that of the solid. This solubilization is accompanied by alteration of the “primary solid” particle and possibly formation of a secondary solid phase. In this embodiment, the ZnB3O4(OH)3 hydrolyzes to a secondary solid phase of insoluble Zn(OH)2 which may form an insoluble surface shell on the ZnB3O4 particle preventing or significantly reducing further solubilization and formation of the soluble orthoboric acid. The zinc borate, ZnB3O4(OH)3, also described as 2ZnO·3B2O3·3·5H2O, is sparingly soluble in water and hydrolyzes incongruently to soluble boric acid and insoluble zinc hydroxide. The produced boric acid is slightly acidic.

It is further theorized that the subsequently formed Zn(OH)2 may decompose of the formula, Zn(OH)2+2H+→Zn2++2H2O, in the presence of a moisture or pH adjuvant, for example. Such decomposition produces zinc ions which may further act as an antimicrobial ion. As can be seen in the zone of inhibition testing the copper oxide alone has some antimicrobial efficacy, zinc borate alone has no significant antimicrobial efficacy, and the combination of copper oxide and zinc borate does not have any synergistic antimicrobial effect.

Since the zinc borate hydrolyzes on the exposed outer portion of the particle to insoluble Zn(OH)2, it would be expected that there would be no further release of zinc ions. However, a desired concentration of pH adjuvant or water can control further decomposition of the insoluble Zn(OH)2 to further release the antimicrobial zinc ions. In this manner, the polymeric composition or article comprises a fast or slow release of antimicrobial metal ions. The metal ions in the metal oxide and the metal borate may be further chosen to provide antimicrobial efficacy by different mechanisms thereby killing a wider range of microbes or combining to kill microbes more effectively. In embodiments, the synergistic compounds may be chosen to affect or control the release of antimicrobial ions, antimicrobial efficacy, antimicrobial durability, color stabilization, or other properties.

### Polymers

Polymer foams are materials that consist of a polymer matrix with a significant volume of gas-filled cells dispersed throughout the polymer matrix. The polymer matrix is a solid phase, and the gas-filled cells contribute to the material's lightweight and porous structure. These foams exhibit unique properties such as rigid foams, flexible foams, low density, thermally insulating, and cushioning, making them suitable for a wide range of applications.

The polymer matrix can be made from various types of polymers, including thermoplastics (e.g., polyethylene, polypropylene), thermosetting plastics (e.g., polyurethane, epoxy), and elastomers (e.g., rubber). The choice of polymer and processing conditions is based upon the desired mechanical, thermal, and chemical properties of the resultant. The gas-filled cells may comprise an open or closed cell structure. This cellular structure contributes to the foam's low density and insulation properties.

Polymer foams include ethylene-vinyl acetate (EVA) foam (copolymers of ethylene and vinyl acetate, also referred to as polyethylene-vinyl acetate (PEVA)), low-density polyethylene (LDPE) foam, nitrile rubber (NBR) foam (copolymers of acrylonitrile (ACN) and butadiene), polychloroprene foam or neoprene, polyimide foam, polypropylene (PP) foam (including expanded polypropylene (EPP) and polypropylene paper (PPP)), polystyrene (PS) foam (including expanded polystyrene (EPS), extruded polystyrene foam (XPS), polystyrene (including extruded polystyrene), polyurethane (PU) foam (copolymers of isocyanates and polyols), low-resilience polyurethane or memory foam, polyurea foam, polyethylene foam, polypropylene foams, polyolefin foams, polyvinyl chloride (PVC) foam, closed-cell polyvinyl chloride foamboard, silicone foam, or combinations thereof, for example.

Polymer foams are typically produced through a foaming process, which involves the incorporation of a blowing agent into the polymer reaction. The blowing agent can be a chemical that decomposes to release gas, or a physical gas introduced during processing. Polymer foams find applications in a variety of industries, including construction, automotive, packaging, electronics, and medical. The foams are used for insulation, cushioning, buoyancy aids, sound absorption, and as structural components in lightweight applications.

Polyurethane foams may be used in furniture, mattresses, insulation, and packaging; polystyrene foam may be used as insulation, packaging, and disposable food containers; polyethylene foam may be used in packaging and cushioning; and polyvinyl chloride (PVC) foam may be used in construction, automotive interiors, and signage, for example.

The polymer foam may further comprise one of polyvinyl chloride, polyolefins, polyethylene, polypropylene, polyethylene phthalate, polydienes, polybutadiene, polyesters, polystyrene, polystyrene acrylonitrile, acid polymers, nylon polymers, bakelite, polyolefins, polyethylene, polypropylene, polyallomer, polyacetal, polyamide, polyvinyl chloride, polyesters, polyethers, polyamides, polyacrylates, polymethacrylates, polyacrylics, acrylonitrile-butadiene-styrene, acrylonitrile styrene acrylate, nylons, polybutylene, polylactic acid, polyurethane, fluoropolymers (such as polytetrafluoroethylene), blended polymers thereof, or copolymers thereof.

### Polyol

The polyol may be any polyol capable of reacting with an isocyanate to form a polymer. As used herein, a “polyol” is a chemical compound having at least two hydroxyl groups including, but not limited to, a difunctional polyol or a diol and a compound comprising more than two hydroxyl groups, such as, but not limited to, a triol. In embodiments, exemplary polyols may possess from about 2 to about 5 hydroxyl groups. In some embodiments, the polyol may be a difunctional polyol. Additionally, the polyol may comprise amino-terminated groups.

In embodiments, a polyol may be an alkene oxide polyol, ethylene oxide polyol, propylene oxide polyol, polyether polyol, polyester polyol, polycarbonate polyol, hydrocarbon polyol, polysiloxane polyol, copolymer polyols of these polymers, combinations thereof, and the like.

### Isocyanates

In embodiments, the isocyanate may be at least one of methylene diphenyl diisocyanate, toluene diisocyanate, and a combination thereof.

Another embodiment is an antimicrobial polyurethane article. The antimicrobial polyurethane article may be a foam, fiber, coating, elastomer, or other article. An embodiment of the antimicrobial polyurethane article comprises a polyurethane and a plurality of antimicrobial particles, wherein at least a portion of the antimicrobial particles are modified to be hydrophobic.

Embodiments of the antimicrobial polyurethane article may comprise monomers derived from the reaction of a polyol and an isocyanate. The isocyanate may be selected from a group including, but not limited to, methylene diphenyl diisocyanate, a toluene diisocyanate, and combinations thereof.

### Antimicrobial Particle

An antimicrobial metal compound may be any water insoluble metal compound that releases the antimicrobial ions when in contact with water. The antimicrobial metal particle comprises at least one of antimicrobial copper compounds, antimicrobial silver compounds, antimicrobial zinc compounds, and other antimicrobial metallic compounds. For example, the antimicrobial metal compounds include, but are not limited to, copper oxide, copper chlorides, cuprous oxide, cupric oxide, copper iodides, copper carbonates, silver oxide, silver chlorides, zinc oxide, zinc chlorides, zinc pyrithione, gold oxide, or combinations thereof, for example. In another embodiment, the particles may consist essentially of one antimicrobial metal compound selected from the group consisting of include, but are not limited to, copper oxide, cuprous oxide, cupric oxide, copper iodides, copper carbonates, silver oxide, zinc oxide, zinc pyrithione, gold oxide, or combinations thereof for example.

In certain embodiments, the antimicrobial compounds or particles may consist essentially of one of a copper oxide, cooper chlorides, cuprous oxide, cupric oxide, copper iodides, copper carbonates, silver oxide, silver chlorides, zinc oxide, zinc chlorides, zinc pyrithione, gold oxide, or combinations thereof, for example. In another embodiment, the particles may consist essentially of one antimicrobial metal compound selected from the group consisting of include, but are not limited to, copper oxide, cuprous oxide, cupric oxide, copper iodide, copper carbonate, silver oxide, zinc oxide, zinc pyrithione, gold oxide. The antimicrobial particle comprising the water insoluble metal compound may comprise functionality or coating. The functionality or coating may assist in the processing or final product properties, for example.

Metal oxide powders comprising at least one of water-insoluble copper oxide particles, silver oxide, zinc oxides may be particularly useful in embodiments of the antimicrobial compositions or articles. The antimicrobial particles may be antimicrobial particles consisting essentially of copper oxide, silver oxide, or zinc oxide, for example.

In some embodiments, the particles comprising or consisting essentially of antimicrobial metal compound particles are mechanically held in the polymer matrix, and not ionically bound, hydrogen bonded, coordination complexed, etc. to the polymer.

The polyurethane foam may comprise water insoluble antimicrobial metal compound that release antimicrobial ions upon contact with a fluid in a concentration from 0.01 wt. % to 10 wt. % of the antimicrobial polyurethane foam; in another embodiment more advantageous for certain applications, copper oxide or other antimicrobial metal compounds may be in a concentration from 0.1 wt. % to 2 wt. % of the weight of the polymer foam or polyurethane foam. In still other embodiment more advantageous for certain applications, copper oxide or other antimicrobial metal compounds may be in a concentration from 0.1 wt. % to 5.0 wt. % of the weight of the polymer foam or polyurethane foam. The particles comprising antimicrobial metal compounds may be in any effective concentration and paired with any synergistic amount of boric compound.

### Boric Compounds

The synergistic compound or a component of a synergistic blend of components may comprise a boric compound. The boric compound may include, but is not limited to, a metal borate, silver borate, copper borate, zinc borate, gold borate, sodium borate, calcium borate, potassium borate, boric salts, boric acid, a compound that produces boric acid and an antimicrobial metal ion on contact with water, and combinations thereof. For example, a metal borate decomposes to release an antimicrobial ion in the presence of the water or pH adjuvant, even though the metal borate has no significant inherent antimicrobial efficacy alone. In some embodiments, the boric compound or the particles comprising a boric compound may be replaced with another compound that synergistically interacts with water or the pH adjuvant and the antimicrobial metal compound to increase the efficacy of the polymeric article over the article comprising only an antimicrobial metal compound.

The boric compounds may be chosen to control antimicrobial efficacy, the durability of the antimicrobial efficacy, color stability, and/or processability of the polymer resin to produce the final product by spinning, drawing, extruding, or molding, for example.

The polyurethane foam may comprise particles comprising boric compounds in a concentration from 0.05 wt. % to 15 wt. % of the antimicrobial polyurethane foam; in another embodiment more advantageous for certain applications, zinc borate or other boric compounds may be in a concentration from 0.1 wt. % to 10 wt. % of the weight of the polymer foam or polyurethane foam. In still other embodiments more advantageous for certain applications, zinc borate or other boric compounds may be in a concentration from 0.1 wt. % to 5.0 wt. % of the weight of the polymer foam or polyurethane foam.

### pH Adjuvants

The pH adjuvant is a compound that creates acidic environment upon contact with a fluid to facilitate the hydrolyzation of metal borate to release an antimicrobial metal ion and/or release of the metal ions from the antimicrobial composition. The pH adjuvant may decompose or dissociate to form an acidic environment. The pH adjuvant creates a microenvironment in response to an external stimulus to adjust the pH on the surface of the antimicrobial polymeric article. In some embodiments, the pH adjuvant has a decomposition temperature above the compounding and forming (extruding or molding) temperatures of the polymeric article. In other embodiments, the pH adjuvant may be formed from the decomposition of a compound due to exposure of the compound to elevated temperatures in the compounding, molding, extruding, or other processing step.

For example, molybdenum oxide decomposes into molybdic acid and hydronium ions when in contact with humidity or other source of water of the following formula:

MoO3+3H2O→2H3O++MoO42−

Other acids will also form hydronium ions that decompose the metal borate to boric acid and release metal ions. The hydronium ions may accelerate the ionization of the metal borate and antimicrobial metal compound to form a synergistic antimicrobial product with higher antimicrobial efficacy than the additive antimicrobial efficacy of the individual components.

In some embodiments, the pH adjuvant is in a concentration from 0.01 wt. % to 5.0 wt. %.

The pH adjuvant may be chosen to control antimicrobial efficacy, the durability of the antimicrobial efficacy, color stability, and/or processability of the polymer resin to produce the final product by spinning, drawing, extruding, or molding. Examples of pH adjuvants include but are not limited to, sulphur, acids including, but not limited to, citric acid, phosphoric acid, etc.; acidic salts including, but not limited to, NaH2PO4, ZnCl2, NH4Cl, and acidic oxides including, but not limited to, MoO3, CrO3, Mn2O7, etc. Therefore, the pH adjuvant may be one of a compound that produces an acidic environment on contact with water, acidic oxide, acidic salt, molybdenum oxide, chromium oxide, chromium chloride, molybdenum chloride, and combinations thereof.

The acid dissociation constant, pKa, of an acid may be used to determine if the compound will create an appropriate acidic environment upon contact with moisture to sufficiently hydrolyze the metal borate and to accelerate the release of the antimicrobial metal ions (Cu+ ions and Cu++ ions from copper oxide, for example) for the desired properties of the polymeric product.

The polymeric article may further comprise a pH adjuvant package comprising one or more pH adjuvant. The pH adjuvant may comprise an acid and a buffer, for example. The buffer may be an acidic buffer or an alkaline buffer, for example. An acidic buffer may comprise weak acid and an acidic salt, for example. Similarly, an alkaline buffer may comprise a weak base and a basic salt, for example.

Methods of forming the antimicrobial polymeric compositions or articles include processing steps that include elevated temperatures for compounding, curing, melting, forming, or softening the polymer. In certain applications, the pH adjuvant has a decomposition temperature above these processing temperatures so all or a portion of the pH adjuvant does not decompose or dissociate during processing.

### Powder Blends

Embodiments of the antimicrobial powders may comprise a blend of synergistic antimicrobial powders. The synergistic powders may be individually blended into a polymer resin or an aqueous dispersion to produce an antimicrobial composition that may be further processed to form antimicrobial articles. For example, an embodiment of the synergistic antimicrobial powders may comprise particles comprising water insoluble metal compounds, and particles comprising boric compounds. The water insoluble antimicrobial powder may comprise a ratio of metal oxide particles to particles comprising boric compounds of between 20:1 to 1:10.

The synergistic antimicrobial powders may be added to the polymer to produce an antimicrobial polymer article comprising antimicrobial metal oxide in a concentration from 0.1 wt. % to 5 wt. %.

The particles comprising antimicrobial metal oxides may be particles comprising or consisting essentially of one or more of copper oxide, zinc oxide, silver oxide, gold oxide, or combinations thereof. The particles comprising boric compounds may be particles comprising zinc borate, particles comprising copper borate, particles comprising silver borate, particles comprising calcium borate, particles comprising sodium borate, or combinations thereof such particles or particles comprising one or more of the boric compounds, for example. In one embodiment, a blend of synergistic antimicrobial powders comprises particles comprising water insoluble antimicrobial copper oxide and particles comprising zinc borate.

In another embodiment, the blend of synergistic antimicrobial powders further comprises a pH adjuvant. Therefore, in one embodiment, the blend of synergistic antimicrobial powders may comprise particles comprising antimicrobial metal compound, particles comprising a boric compound, and particles comprising a pH adjuvant.

In specific embodiment, the blend of synergistic powders comprises copper oxide and zinc borate. In another embodiment, the blend of synergistic powders comprises copper oxide, molybdenum oxide, and zinc borate.

### Masterbatch

An antimicrobial masterbatch may be blended with virgin polymer to add desired color or other properties to the virgin polymer prior to further processing to form antimicrobial polymeric articles, fibers, yarns, fabrics, or other articles. Methods and processes for producing an antimicrobial and/or antiviral polymeric masterbatch. The synergistic antimicrobial compounds described herein may be added to a virgin polymer to produce the masterbatch and subsequently the masterbatch may be added to a virgin polymer to produce an antimicrobial polymeric resin.

The masterbatch may be extruded into pellets, chips, or formed into other particles for subsequent blending with the virgin polymer to add antimicrobial, antiviral, or antifungal properties to the polymeric materials.

Embodiments of the polymeric masterbatch for preparing antimicrobial polymer materials may comprise a thermoplastic resin, a blend of antimicrobial synergistic compounds comprising particles of water insoluble antimicrobial metal compounds (as described herein) and boric compounds (as described herein). The masterbatch may further comprise a polymeric wax, an agent for occupying the charge of the ionic copper oxide, processing aids, or other property modifying agents The antimicrobial synergistic compounds may further comprise particles comprising a pH adjuvant.

A method of producing an antimicrobial article, film, fiber, yarn, or other molded or extruded article, comprises adding a polymeric antimicrobial masterbatch comprising a thermoplastic resin, a blend of antimicrobial synergistic compounds comprising water insoluble particles of copper oxide and zinc borate to a thermoplastic polymeric resin and forming the antimicrobial article, film, fiber, yarn, and other molded or extruded articles.

A method of producing an antimicrobial article, film, fiber, yarn, or other molded or extruded article, comprises adding a first polymeric masterbatch comprising a thermoplastic resin, a blend of antimicrobial synergistic compounds comprising water insoluble particles of copper oxide, pH adjuvant, and zinc borate to a thermoplastic polymeric resin; adding a second masterbatch comprising at least one of the antimicrobial synergistic compounds comprising particles of water insoluble copper oxide, pH adjuvant, and zinc borate, wherein the second masterbatch comprises at least one of the synergistic compounds that is not included in the first polymeric masterbatch, and forming the antimicrobial article, film, fiber, yarn, and other molded or extruded article.

For example, the first polymeric masterbatch may consist essentially of particles of water insoluble copper oxide and particles of zinc borate and the second polymeric masterbatch may comprise the pH adjuvant such as molybdenum oxide.

Further embodiments of the polymeric masterbatch for preparing antimicrobial polymer materials may comprise a thermoplastic resin, particles of a blend of antimicrobial synergistic compounds comprising water insoluble metal compounds such as copper oxide, for example, and particles of a boric compound such as zinc borate, for example, a polymeric wax, and an agent for occupying the charge of the ionic copper oxide. The antimicrobial synergistic compounds may further comprise a pH adjuvant.

Antimicrobial, antifungal, and/or antiviral masterbatch allows a polymeric product producer to add antimicrobial and/or antiviral components economically to polymers during the manufacturing process. More particularly, the present invention relates to an improved process and masterbatch for preparing antimicrobial and antiviral polymeric materials having a multitude of antimicrobial uses.

Embodiments of the antimicrobial powders may comprise a blend of synergistic antimicrobial powders. The blend of synergistic powders may be blended into a polymer resin to produce an antimicrobial polymer that may be further processed to form antimicrobial articles. The water insoluble antimicrobial powder may comprise a ratio of metal oxide particles to particles comprising boric compounds of between 20:1 to 1:1. Any of the antimicrobial masterbatches described herein may comprise the blend of antimicrobial synergistic compounds or a subset of the blend of antimicrobial synergistic compounds in a concentration from 10 wt. % to 70 wt. %, for example.

The synergistic antimicrobial powders may be added to the polymeric resin to produce an antimicrobial polymer article comprising particles comprising antimicrobial metal oxide sin a concentration from 0.1 wt. % to 5 wt. %.

An embodiment of a first antimicrobial masterbatch may comprise antimicrobial particles comprising at least one water insoluble antimicrobial metal compound and at least one boric compound embedded in a polymer, wherein the antimicrobial masterbatch comprises antimicrobial particles in a concentration from 12 wt. % to 50 wt. %.

An embodiment of a second masterbatch may comprise molybdenum oxide particles, wherein the second masterbatch comprises molybdenum oxide particles in a concentration from 5 wt. % to 50 wt. %.

An embodiment of a third masterbatch may comprise a blend of particles comprising antimicrobial metal compounds, a boric compound, and a pH adjuvant, wherein the third masterbatch comprises the blend of particles in a concentration from 5 wt. % to 50 wt. %.

A method of producing an antimicrobial fiber, nonwoven, film, or other extruded or molded article, comprising compounding the first antimicrobial masterbatch with a polymer. The method may further comprise compounding the first antimicrobial masterbatch, the second masterbatch and the polymer to produce a polymeric article comprising a metal oxide, a metal borate, and molybdenum oxides.

### EMBODIMENTS

### Floor Covering Assembly

Embodiments of a floor covering may include, but are not limited to, a mat, rug, carpet, laminate flooring, or other floor covering comprising one or more layers designed to protect the surface or area to which it is applied. The embodiment may be designed to be temporary, semi-permanent, or permanent in installation. The mat, rug, carpet, laminate flooring, or other floor covering may comprise any of the synergistic combinations of particles described herein in any of the layers or fibers of the floor covering.

The embodiment may be designed re-usable and washable, re-usable and non-washable, or disposable with inherent antimicrobial or material preservation protection.

For example, in one embodiment, a bath rug may comprise a knitted polyester fabric top layer comprising between 0.5 wt % and 3.0 wt. % of an antimicrobial metal compound (for example, 1 wt. % cuprous oxide), between 0.5 wt % and 3.0 wt. % of a boric compound (for example, 1 wt. % zinc borate), pigment, and a polymeric wax. The average particle size of the particles in the top layer ranges from 1 to 5 μm. Below the top layer may be a polyurethane foam base layer (1 to 2 mm thick, for example) embedded with between 0.1 wt % and 4.0 wt. % antimicrobial metal compound (for example, 1.5 wt. % cuprous oxide) and between 0.1 wt % and 4.0 wt. % (for example, 1.5 wt. % zinc borate). The cuprous oxide particles in the base layer may be hydrophobically treated. The polyurethane foam base layer may be made from a polyethylene glycol-based polyol to enhance hydrophilicity. Beneath the base layer may be a polyvinyl chloride bottom layer embedded with between 0.1 wt % and 4.0 wt. % antimicrobial metal compound (for example, 0.5 wt. % cuprous oxide) and between 0.5 wt % and 3.0 wt. % of a boric compound (for example, 2 wt. % zinc borate). The average particle size in the base layer and the bottom may be 4 to 7 μm. Optionally, 0.1 wt. % to 1 wt. % pH adjuvant may be added to the material of any layer.

### EXAMPLES

### Zone of Inhibition (ZOI)

Materials. Cupron copper oxide (Cu2O) particles were supplied by Cupron, LLC. Antimony oxide (Antimony (III) oxide, Sb2O3, 99%), molybdenum oxide (molybdenum (VI) oxide, MoO3, 99.5%), sodium borate (sodium tetraborate, Na2B4O7, 99.5%), boric acid (H3BO3, 99.5%), zinc oxide (ZnO, 99.5%), sodium molybdate (sodium molybdate (VI) dihydrate, Na2MoO4·2H2O, 99%), calcium chloride (CaCl2), 97%) sodium citrate (Na3C6H5O7, lab grade), magnesium sulfate (magnesium sulfate, heptahydrate, MgSO4·7H2O, 99%), basic copper(II) carbonate (BCC) were purchased from Fisher. Zinc chloride (ZnCl2, 98%) and zinc bromide (ZnBr2, 98%) were bought from Thermo Scientific. Zinc sulfate (zinc sulfate monohydrate, ZnSO4·H2O) was obtained from Alpha Chemicals. Zinc borate (Firebrake ZB) was provided by U.S. Borax. Microcrystalline cellulose powder was purchased from LFA Tablet Presses Store. Aspartic acid (98%) was purchased from Acros organics. Molybdic acid, Potassium borate, Chromium(III) chloride, Chromium(VI) oxide, Molybdenum(V) chloride, Molybdenum disulfide, Chromium(III) hydroxide were bought from Fisher. All the chemicals were used as received.

Sample preparation. Sample pellets were made from the chemical powders using an DABPRESS 4-ton hydraulic press. The weight percentage of each powder component is specified in Table 1 and 2. Microcrystalline cellulose powder (20 wt %) was added as a binding agent. The chemical powders were mixed by vortexing for 20 s to ensure mixing. Then, 0.2 g powder blend was added to each hole of a 12 holes aluminium tablet mold (hole diameter=10 mm). The tablet mold was then pressed by using the hydraulic press to yield sample pellets.

Zone of Inhibition (ZOI). E. coli (ATCC 8739) was used for the ZOI tests. The cultures were streaked on Luria Agar (LB) plates and incubated overnight at 37° C. A single colony was used to inoculate 10 ml of nutrient broth (NB) and grown overnight at 37° C. with rocking and a stock suspension of (^{~}109) colony-forming units per milliliter (CFU/mL) was obtained. 50 μL of this stock suspension was spread homogeneously on a trypticase soy agar (TSA) plate (diameter 10 cm). Sample pellets (§ triplicates) containing copper oxide and the adjuvants were then placed on the agar and incubated for 24 h at 37° C. The diameter of the inhibition zones around the sample pellets were measured using a ruler and the results are summarized in Table 1 and 2.

Results. As a screening test, Cupron copper oxide particles and its blends with 14 different adjuvants were investigated in the ZOI study to explore the potential synergy for antimicrobial effectiveness. The results of this study are summarized in Table 1. The diameter of the ZOI for copper oxide alone was found to be 13 mm against E. coli after 24 h incubation at 37° C. Significant increased ZOI dimension was observed when copper oxide was blended with molybdenum oxide, sodium borate, borate acid, zinc chloride, zinc bromide, zinc sulfate, calcium chloride, molybdic acid, potassium borate, chromium(III) chloride, chromium(VI) oxide, molybdenum(V) chloride, and molybdenum disulfide, suggesting that these chemicals improved the antimicrobial effectiveness of copper oxide against E. coli. No effect on the ZOI diameter was found for antimony oxide, zinc borate, zinc oxide, sodium molybdate, sodium citrate, magnesium sulfate, aspartic acid, and chromium(III) hydroxide. These results suggested that (1) molybdenum oxide, chromium(III) chloride, chromium(VI) oxide and molybdenum(V) chloride may improve the copper ion release by reducing the environmental pH. (2) Zinc borate alone had no impact on the antimicrobial effectiveness of copper oxide. However, the hydrolyzation products of zinc borate in an acidic environment, including boric acid, zinc chloride, zinc bromide and zinc sulfate, improved the antimicrobial effectiveness of copper oxide significantly. (3) Sodium borate and potassium borate, as basic salts, improved the antimicrobial effectiveness of copper oxide, indicating that borate ion has synergistic effect with copper oxide that resulted in a greater antimicrobial effectiveness. Thus, it is not necessary to reduce the pH in order to enhance the antimicrobial effectiveness of Cupron copper oxide. Beside the results discussed above, calcium chloride and molybdenum disulfide were also found to increase the diameter of ZOI when blended with copper oxide. Future studies are needed to find out the reason of this result. The results described above suggested that the hydrolyzation products of zinc borate in acidic environments improved the antimicrobial effectiveness of copper oxide. It has been reported that molybdenum oxide reacts with water and reduces the environmental pH. Thus, the presence of molybdenum may create a desirable environment for the hydrolyzation of zinc borate, and hence a synergy on antimicrobial effectiveness may exist among copper oxide, molybdenum oxide and zinc borate. To validate this theory, the ZOI study shown in Table 2 was carried out. The diameter of the ZOI for was found to be 13 mm and 19 mm for copper oxide and molybdenum oxide respectively. No ZOI was observed for zinc borate. The blends of copper oxide and zinc borate had 12 to 13 mm ZOI with zinc borate content ranging from 20% to 70% (Table 2, Test #4, 7, 10 and 13), indicating that zinc borate alone does not affect the antimicrobial effectiveness of copper oxide in this study. The ZOI for the blends of copper oxide and molybdenum oxide were larger than the that for copper oxide alone, and the ZOI dimension increased with increasing molybdenum oxide content (Table 2, Test #5, 8, 11 and 14). Remarkably, the largest ZOI was observed for the blends of copper oxide, molybdenum oxide and zinc borate, particularly for the blends with higher contents of molybdenum oxide and zinc borate (Table 2, Test #9, 12 and 15). The result confirmed the synergistic effect among copper oxide, zinc borate and molybdenum oxide on the antimicrobial effectiveness against E. coli.

To extend the field of application to the synergy described above, BCC was used as a

TABLE 3
ZOI test results for the blends of basic copper(II) carbonate (BCC), antimony oxide, zinc borate and
molybdenum oxide against E. coli, after 24 h incubation at 37° C. Cellulose was used as a binder.

| Test | | Antimony | Zinc | Molybdenum | | Zone of Inhibition Diameter (mm) | | | | |
|---|---|---|---|---|---|---|---|---|---|---|
| # | BCC | oxide | borate | oxide | Cellulose | Trial 1 | Trial 2 | Trial 3 | Avg | Stdev |
| 1 | 80% | 0% | 0% | 0% | 20% | 12 | 12 | 13 | 12 | 0.6 |
| 2 | 40% | 40% | 0% | 0% | 20% | 11 | 11 | 11 | 11 | 0.0 |
| 3 | 40% | 0% | 40% | 0% | 20% | 11 | 11 | 11 | 11 | 0.0 |
| 4 | 40% | 0% | 0% | 40% | 20% | 20 | 22 | 18 | 20 | 2.0 |
| 5 | 40% | 20% | 20% | 0% | 20% | 11 | 11 | 11 | 11 | 0.0 |
| 6 | 40% | 20% | 0% | 20% | 20% | 18 | 18 | 19 | 18 | 0.6 |
| 7 | 40% | 0% | 20% | 20% | 20% | 24 | 25 | 25 | 25 | 0.6 |
| 8 | 40% | 10% | 10% | 20% | 20% | 22 | 23 | 22 | 22 | 0.6 |

replacement for copper oxide in the ZOI study. As shown in Table 3, BCC was blended with antimony oxide, zinc borate and molybdenum oxide and the diameter of ZOI for the blends was measured. The diameter of the ZOI for was found to be 12 mm for BCC alone. The blends of BCC and antimony or zinc borate had 11 mm ZOI (Table 3, Test #2 and 3), indicating that zinc borate or antimony oxide does not affect the antimicrobial effectiveness of BCC in this study. The ZOI for the blends of copper oxide and molybdenum oxide were found to be much larger (20 mm, Table 3, Test #4)) than the that for BCC alone (11 mm, Table 3, Test #1). BCC was then blended with the mixture of antimony oxide and zinc borate (Table 3, test #5), the mixture of antimony oxide and molybdenum oxide (Table 3, Test #6) and the mixture of zinc borate and molybdenum oxide (Table 3, Test #7). No noticeable changed of ZOI (11 mm) was observed for BCC after blended with antimony oxide and zinc borate. The blend of BCC with antimony oxide and molybdenum oxide had a ZOI diameter of 18 mm, which is larger than the ZOI diameter for BCC alone but smaller than the blend of BCC and molybdenum. This result suggested that the enlarged ZOI for the blend of BCC with antimony oxide and molybdenum is mainly attributed to the synergy between BCC and molybdenum, but the addition of antimony oxide had no significant synergistic effect with BCC or molybdenum for the antimicrobial effectiveness. The largest ZOI was observed for the blend of BCC with the mixture of zinc borate and molybdenum oxide (25 mm, Table 3, Test #7), which indicated that zinc borate and molybdenum oxide could synergy with various copper compounds to result in a greater antimicrobial effectiveness. At last, BCC was blended with the mixture of antimony oxide, zinc borate and molybdenum oxide. The addition of antimony oxide slightly reduced the size of ZOI to 22 mm, indicating that antimony oxide does not improve the antimicrobial effect for copper compounds.

### Fabric Sample Preparation

TABLE 4
PET fabric sample compositions.

| | Copper | Zinc | Molybdenum |
|---|---|---|---|
| | oxide | borate | oxide |
| | content | content | content |
| Sample # | (wt. %) | (wt. %) | (wt. %) |
| Control | 0.00% | 0.00% | 0.00% |
| 1 | 0.10% | 0.00% | 0.00% |
| 2 | 0.30% | 0.00% | 0.00% |
| 3 | 0.60% | 0.00% | 0.00% |
| 4 | 1.00% | 0.00% | 0.00% |
| 5 | 1.20% | 0.00% | 0.00% |
| 6 | 0.00% | 0.60% | 0.00% |
| 7 | 0.00% | 1.00% | 0.00% |
| 8 | 0.50% | 0.50% | 0.00% |
| 9 | 0.60% | 0.60% | 0.00% |
| 10 | 0.10% | 0.60% | 0.30% |
| 11 | 0.30% | 0.60% | 0.30% |
| 12 | 0.60% | 0.60% | 0.30% |

The compositions of the PET fibers embedded with copper oxide particles, zinc borate particles and molybdenum oxide particles are summarized in Table 4. The fibers were produced through melt extrusion. These fibers were brought together to from yarn. As the fibers were brought together to form the yarns they were air-cooled/quenched to solidify the yarns. The yarns were knitted into 4″ wide sleeves using a Lawson knitter.

### Anti-Mold Study 1

Experimental. To assess their performance against Aspergillus Niger (AN) mold spores, 2×2″ samples of polyethylene terephthalate (PET) fabric were carefully cut from Lawson sleeves. These fabric samples curled along their length and formed stripe shape. Samples #4, 7, 8, 10, 11, 12 and the untreated PET control were involved in this test. Table 4. AN was inoculated on Trypticase soy agar (TSA) and was incubated at 37° C. After 2 weeks of growth, the spores were harvested by placing 15 ml DI water in the TSA plates and gently scraping the agar surface with a L-shaped cell spreader. The spore suspension was transferred to a test tube and diluted 10 times in sabouraud dextrose broth (SDB) to generate a stock suspension. The stock suspension (5 μL) was inoculated on each TSA plate and was carefully spread on the entire surface. The PET fabric samples were placed on the inoculated TSA plates. 200 μL stock suspension was then carefully added on the fabric sample surfaces drop wisely. Efforts were made to ensure the uniform distribution of stock suspension distribute on the sample surfaces. The samples were inoculated at 37° C. for 1 month to evaluate the fabric's effectiveness in inhibiting mold growth. After the incubation period, a rating scale between 0-4 determines the antifungal efficacy of tested materials. Ratings are described as below.
0—No growth on the specimen
1—Traces of growth on the specimen (less than 10%)
2—Light growth (10 to 30%)
3—Medium growth (30 to 60%)
4—Specimens completely covered with growth (60%)

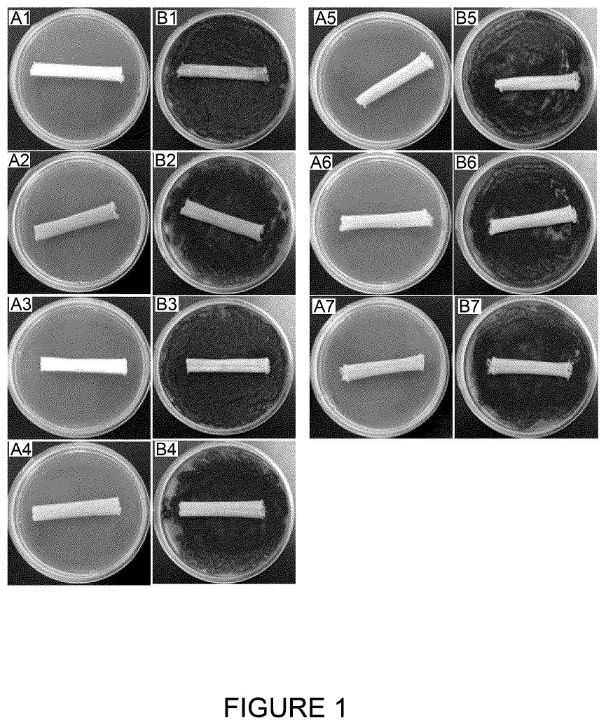

Results. The images of AN mold growth on PET sample surfaces before and after 4-week incubation are shown in FIG. 1. The compositions of the samples are specified in Table 4, and their corresponding anti-mold rates are summarized in Table 5. FIG. 1 clearly demonstrates that the untreated PET control sample was heavily contaminated with AN mold after the 4-week incubation period (FIGS. 1, A1 and B1). The surface of the control sample was completely covered with black AN mold, thus warranting an anti-mold rate of 4 for the untreated PET control (Table 5). However, PET fabrics embedded with 1% copper oxide (Table 5, Sample #4) or 1% zinc borate (Table 5, Sample #7) exhibited improved anti-mold effectiveness. Although both Sample #4 and Sample #7 displayed noticeable mold growth on their surfaces, it was significantly less compared to the untreated control. (FIGS. 1, A2 and B2, A3 and B3) Therefore, an anti-mold rate of 2 was assigned to both Sample #4 and Sample #7 in Table 5. Sample #8, containing 0.5% copper oxide and 0.5% zinc borate, performed better than Sample #4 and Sample #8 in terms of mold resistance. As shown in FIGS. 1A4 and 1B4, Sample #8 did not completely stop the mold overgrowth, but it was barely noticeable after 4-week incubation was barely noticeable. As a result, an anti-mold rate of 1 was assigned to Sample #8. The introduction of molybdenum oxide further enhanced the anti-mold properties. Sample #10, comprising 0.1% copper oxide, 0.6% zinc borate, and 0.3% molybdenum oxide, performed similarly to Sample #8 (FIGS. 1, A5 and B5), achieved an anti-mold rate of 1. Furthermore, Sample #11 and Sample #12, which both contained zinc borate and molybdenum oxide but had a higher copper oxide content compared to Sample #10, attained an anti-mold rate of 0. Remarkably, there was no noticeable AN overgrowth observed on Sample #11 and #12 after the 4-week incubation period. (FIGS. 1, A6 and B6, A7 and B7)

To summarize, the combination of zinc borate with copper oxide significantly improved the overall anti-mold properties of PET fabric samples. This was evident in the results, where the PET sample containing 0.5% copper oxide and 0.5% zinc borate outperformed the samples with either 1% copper oxide or 1% zinc borate alone in preventing AN mold overgrowth. These findings suggest a synergistic effect between copper oxide and zinc borate in inhibiting AN mold growth. Furthermore, the addition of molybdenum oxide further enhanced the resistance of the samples to mold growth. PET fabric samples with 0.3% molybdenum oxide, 0.6% zinc borate, and 0.3% or higher copper oxide were able to completely prevent AN mold overgrowth throughout the duration of the study.

TABLE 5
PET fabric sample compositions and their anti-mold rate.

| | Anti-mold |
|---|---|
| Sample # | rate |
| Control | 4 |
| Sample # 4 | 2 |
| Sample # 7 | 2 |
| Sample # 8 | 1 |
| Sample # 10 | 1 |
| Sample # 11 | 0 |
| Sample # 12 | 0 |

In conclusion, incorporating zinc borate alongside copper oxide in PET fabric samples showed significant improvements in their anti-mold properties, and the inclusion of molybdenum oxide further enhanced their effectiveness in inhibiting mold growth. These findings highlight the potential of these additives in developing mold-resistant PET fabrics.

### Anti-Mold Study 2

Experimental. 1″ long samples of PET fabric were carefully cut from Lawson sleeves and were placed in 20 mL clear sample vials with caps. Samples #3, 5, 6, 9 in Table 4 and the untreated PET control were involved in this test. AN was inoculated in Sabouraud Dextrose Broth (SDB) and was incubated at 37° C. After 1 weeks of growth, the AN suspension was transferred to a test tube and diluted 10 times in sabouraud dextrose broth (SDB) to generate a stock suspension. The stock suspension (5 mL) was carefully spread on the entire sample surface. The caps of the vials were loosely closed to allow air exchange. The samples were inoculated at 22° C. for 1 week to evaluate the fabric's effectiveness in inhibiting AN mold growth.

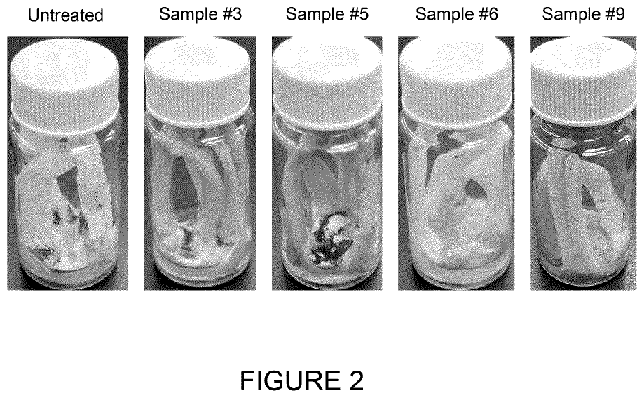

Results. The effectiveness of PET fabric samples in preventing mold growth is illustrated in FIG. 2. After a 1-week incubation at 22° C., notable mold growth was observed in several samples, including the untreated PET control, Samples #3, #5, and #6 (FIG. 2). These samples also exhibited evidence of spore generation, indicated by the presence of black spots. This suggests that using copper oxide or zinc borate alone is insufficient to inhibit AN mold growth in the tested conditions, and in fact, copper oxide even seemed to encourage spore production while zinc borate only partially reduced it.

In contrast, Sample #9 showed only minor mold growth, with no black spore generation detected. This indicates that the combination of copper oxide and zinc borate in Sample #9 is more effective at preventing AN mold growth at 22° C. than using either copper oxide or zinc borate in isolation.

These findings align with the results from a previous anti-mold study (referred to as “anti-mold study 1” in the passage), indicating a consistent pattern of synergy between copper oxide and zinc borate in inhibiting AN mold growth.

In summary, the combination of copper oxide and zinc borate demonstrates superior anti-mold properties compared to using either substance alone. This suggests a synergistic effect between copper oxide and zinc borate, making them a promising choice for preventing AN mold growth in PET fabric samples at 22° C.

### Ion Release Study

Active Copper is determined by measuring the amount Copper ion released from the surface of 1″×1″ PET fabric. The results are summarized in Table 6. A solution consisting of Bicinchoninic acid (BCA), a known copper complexing agent, is prepared in phosphate buffered solution (PBS). Plastic Test substrate is immersed in the BCA solution for 2 hours. During this period, the BCA reacts with copper to form a purple-colored BCA-Copper complex. At the end of 2 hours, a small amount of solution is obtained and the copper in the solution is estimated by colorimetric assay.

TABLE 6
Copper ion release study results.

| | Cu ion release |
|---|---|
| Sample | (ppm/g) |
| Sample #1 | 5.1 |
| Sample #2 | 9.8 |
| Sample #3 | 10.6 |
| Sample #10 | 4.7 |
| Sample #11 | 11.6 |
| Sample #12 | 15.9 |

As shown in Table 6, Test Samples #10, #11 and #12, containing 0.6% zinc borate, 0.3% molybdenum oxide and various copper oxide content have 4.7, 11.6 and 15.9 ppm copper ion released from one gram of sample. Copper ion release rate increased with increasing copper oxide content. Additionally, Test Samples #1, #2, and #3, which contained only copper oxide, released copper ions at rates of 5.1, 9.8, and 10.6 ppm per gram of the sample. This finding demonstrated that the release rate of copper ions increased with higher copper oxide content, regardless of the presence of zinc borate or molybdenum oxide.

Interestingly, Sample #11, which contained 0.3% copper oxide along with zinc borate and molybdenum oxide, exhibited a copper ion release rate of 11.6 ppm per gram, which was 18% higher than that of Sample #2 containing the same amount of copper oxide but without zinc borate and molybdenum oxide. A similar trend was observed for samples with higher copper oxide content. For instance, Sample #12, which contained 0.6% copper oxide along with zinc borate and molybdenum oxide, had a copper ion release rate of 15.9 ppm per gram, which was 50% higher than that of Sample #3 with 10.6 ppm/g copper ion release rate. Except for the samples with 0.1% copper oxide, the addition of zinc borate and molybdenum oxide accelerated the release of copper ions in samples with 0.3% and 0.6% copper oxide. Overall, the results suggested that the presence of zinc borate and molybdenum oxide positively influenced the release of copper ions, leading to higher release rates compared to samples without these additives, especially at higher copper oxide concentrations.

### Antimicrobial Study 1

All polymeric samples were evaluated using ISO-22196 test method for antimicrobial efficacy. For antimicrobial efficacy testing, 1-inch×1-inch samples were cut from the PET fabric Lawson sleeves. The composition of the samples used in this study is shown in Table 4. Samples #1, 2, 3, 5, 9, 10, 11, and 12 were involved in this study. An untreated PET fabric sample was included as control. The 1″×1″ samples were inoculated with pathogen suspensions and covered with a cover slip were incubated for a 2-hour period. Incubation temperature and incubation carrier are summarized in Tables 7 and 8. Immediately after adding the bacteria, bacteria from a set of samples were recovered by stomaching to determine the number of bacteria added to the substrate. After the 2-hour contact time, the bacteria by stomaching. The recovered bacteria were counted via colony forming units using serial dilution method.

The log Reduction values are calculated as per the calculations below:

TABLE 7
Antimicrobial effectiveness against
E. coli using various test conditions.

Log reduction

| | 37° C., | 37° C., |
|---|---|---|
| | 5% NB in | 5% TSB in |
| Sample | saline | saline |
| Sample #1 | 4.9 | 1.6 |
| Sample #2 | 6.7 | 3.3 |
| Sample #3 | 6.9* | 6.2 |
| Sample #10 | 6.9* | 3.2 |
| Sample #11 | 6.9* | 6.5 |
| Sample #12 | 6.9* | 6.4 |

*Detection limited of the test was reached.

$$Log Reduction = {Log}_{10} [ {CFU}_{control} at 2 - hour ] - {Log}_{10} [ {CFU}_{sample} at 2 - hour ]$$

Results. Table 7 summarizes the antimicrobial effectiveness against E. coli under various test conditions. When incubated at 37° C. and using a 5% nutrient broth (NB) in saline inoculation carrier, Sample #1 containing 0.1% copper oxide (without zinc borate or molybdenum) showed a 4.9 log reduction in E. coli bacteria. However, when 0.6% zinc borate and 0.3% molybdenum oxide were added to Sample #1 (creating Sample #10), the efficacy of the substrate increased to greater than 6.9 log reduction, an improvement of over 2.0 log reduction. Similar trends were observed for Sample #2 with 0.3% copper oxide, achieving a 6.7 log reduction, and Sample #11 with 0.3% copper oxide, 0.6% zinc borate, and 0.3% molybdenum oxide, demonstrating greater than 6.9 log reduction. Sample #3 and Sample #12 both achieved greater than 6.9 log reduction, which is the detection limit of this test. These results suggest that the presence of zinc borate and molybdenum oxide enhanced the antimicrobial effectiveness against E. coli at 37° C. with a 5% NB in saline inoculation carrier, particularly at lower copper oxide concentrations.

When using a 5% trypticase soy broth (TSB) in saline inoculation carrier, Sample #1 with 0.1% copper oxide (without zinc borate or molybdenum) displayed a 1.6 log reduction against E. coli bacteria. However, upon adding 0.6% zinc borate and 0.3% molybdenum oxide to Sample #1 (creating Sample #10), the efficacy of the substrate increased to a 3.2 log reduction, an improvement of 1.6 log reduction. A similar trend was observed for Sample #2 with 0.3% copper oxide and Sample #3 with 0.6% copper oxide, achieving 3.3 and 6.2 log reductions, respectively. Additionally, Sample #11 and #12 with zinc borate and molybdenum oxide adjuvants demonstrated greater than 6.5 and 6.4 log reductions, respectively. Again, these results indicate that the presence of zinc borate and molybdenum oxide enhanced the antimicrobial effectiveness against E. coli at 37° C. with a 5% NB in saline inoculation carrier.

TABLE 8
Antimicrobial effectiveness using various
pathogens at 21° C. in synthetic sweat.

Log reduction

| | E. coli | S. aureus | P. aeruginosa |
|---|---|---|---|
| | 21° C., | 21° C., | 21° C., |
| | Synthetic | Synthetic | Synthetic |
| Sample | sweat | sweat | sweat |
| Sample #3 | 3.24 | 4.68 | 5.17* |
| Sample #5 | 3.61 | 5.05 | 5.17* |
| Sample #9 | 3.49 | 3.7 | 5.17* |

*Detection limited of the test was reached.

To understand the influence of zinc borate to antimicrobial effectiveness, antimicrobial study was carried out on Samples #3, 5, and 9 at 21 C in synthetic sweat, which contains 0.5 g/L L-histidine:HCl:H₂O, 5 g/L NaCl, 2.2 g/L Na2PO4·12H₂O, and 15 ml/L 0.1M NaOH. PH was adjusted to 5.5 with HCl before use. As shown in Table 8, all the test samples achieved greater than 3 log reduction for E. coli and greater than 5 log reduction for P. aeruginosa. Negligible difference between samples with copper oxide only (Samples #3 and 5) and samples with copper oxide and zinc borate was found for E. coli and P. aeruginosa. However, the addition of zinc borate appeared to reduce the antimicrobial efficacy against S. aureus under the same test condition. Sample #9 with 0.6% copper oxide and 0.6% zinc borate had 3.7 log reduced against S. aureus. This is 1 log lower than Sample #3 with 0.6% copper and 1.4 log lower than Sample #5 with 1.2% copper oxide. Further studies are required to understand why the antimicrobial efficacy was comprised by the addition of zinc borate.

In conclusion, the presence of zinc borate and molybdenum oxide adjuvants enhanced the antimicrobial effectiveness against E. coli at an elevated temperature of 37° C., but the addition of zinc borate alone was not able to achieve the same effect at ambient temperature.

### Antimicrobial Study 2

TABLE 9
Compositions and antimicrobial effectiveness
using various pathogens for PVC samples.

| | Copper | Zinc | | | |
|---|---|---|---|---|---|
| | oxide | borate | Log Reduction | | |
| Sample | content | content | E. | S. | P. |
| # | (wt. %) | (wt. %) | coli | aureus | aeruginosa |
| 14 | 0.50% | 0.00% | 13 | 0.9 | 2.1 |
| 15 | 0.00% | 2.00% | 0.8 | 1.5 | 1.6 |
| 16 | 0.50% | 2.00% | 3.4 | 5 | 4.5 |

Experimental. To determine the antimicrobial efficacy on different polymer substrates, PVC chip injection moulding process. Sample compositions are specified in Table 9. Prior to experimentation, all test samples (1″×1″) were sterilized under UV in a biosafety safety cabinet for 1 h on each side. Test pathogen was inoculated in growth medium and allowed to grow to saturation in an orbital shaker for 24 h at 37° C. Afterwards, the pathogen suspension was diluted to ^{~}1.0e8 CFU/mL in an inoculum carrier (IC) containing 5 wt. % M3 broth, 0.89 wt. % NaCl, and 0.05 wt. % triton. Two labelled petri dishes per sample with foam inserts were pretreated with 1.5 mL sterilized DI water. Then a PVC sample chip was placed on top of the pretreated foam. Twenty microliters of bacteria-containing IC were then pipetted onto the center of each test sample. A plastic coverslip (22 mm) was then placed on top and pressed gently to spread IC. The petri dishes were then covered and placed in an incubator for 2 h at 37° C. After the incubation period, the petri dishes were removed and the test samples with coverslips were placed in individual 50 ml conical centrifuge tubes containing 17.5 ml of Letheen broth. The 50 ml conical centrifuge tubes were vortexed for 2 min and then solutions were serial diluted and plated on nutrient agar. Agar plates were then placed in an incubator for 24 h at 37° C. and then colonies were counted.

Results. As presented in Table 9, Sample #16, which included both copper oxide and zinc borate, demonstrated notable reductions: a 3.4 log reduction for E. coli, a 5 log reduction for S. aureus, and a 4.5 log reduction for P. aeruginosa. These outcomes surpass the performance of Sample #14 (containing only copper oxide) and Sample #15 (containing only zinc borate). The data suggests a synergistic antimicrobial effect when copper oxide and zinc borate are combined on the PVC substrate.

### Color Shift

Color analysis was conducted using a Konica Minolta chroma meter CR-410, which was first calibrated on a

TABLE 10
Chroma meter results.

| Sample | L* | a* | b* | ΔL* | Δa* | Δb* | ΔE* |
|---|---|---|---|---|---|---|---|
| Sample #3 | 66.75 | 15.49 | 12.85 | −28.80 | 15.71 | 9.17 | 34.07 |
| Sample #5 | 60.89 | 18.36 | 14.15 | −34.66 | 18.58 | 10.48 | 40.70 |
| Sample #9 | 69.65 | 14.67 | 12.52 | −25.86 | 14.89 | 8.85 | 31.63 |
| Sample #12 | 66.57 | 6.90 | 8.53 | −28.99 | 7.12 | 4.86 | 30.24 |

completely white surface prior to the measurements. The summarized results can be found in Table 10, with L*, a*, and b* representing the three values used to objectively measure color and calculate color variations. L* quantifies the degree of lightness on a scale from zero to 100, spanning from black to white, while a* and b* denote chromaticity without specific numerical boundaries. Negative a* values correspond to green hues, positive a* values indicate red hues, negative b* values signify blue hues, and positive b* values represent yellow hues. Delta (Δ) signifies the disparities between the tested surface and a pure white reference. ΔE* serves as a comprehensive measure of the overall difference between the tested surface and a pure white reference, calculated using the following equation:

$$Δ {E}^{*} = {( {( Δ {L}^{*} )}^{2} + {( Δ {a}^{*} )}^{2} + {( Δ {b}^{*} )}^{2} )}^{1 / 2}$$

As shown in Table 10, Sample #9, which contains 0.6% copper oxide and 0.6% zinc borate, exhibits the highest brightness (L*). Sample #12 displays the lowest a* and b* values, implying that the inclusion of 0.6% zinc borate and 0.3% molybdenum oxide effectively mitigated color shifts of copper oxide towards redness and yellowness. Moreover, when considering the overall color shift (ΔE*), it becomes evident that Samples #9 and #12 exhibit substantially lower values compared to Samples #3 and #5. This suggests that the introduction of zinc borate and molybdenum oxide has a significant impact in reducing the color shifts caused by the presence of copper oxide.

### Color Stability to Oxidation

For the investigation of color stability in PET fabric samples, Sample #5 and Sample #12 from Table 4 were selected. The study aimed to assess the effects of a strong oxidizing agent on the color stability of these samples. Specifically, Sample #5 (1.2% copper oxide) and Sample #12 (0.6% copper oxide content with 0.6% zinc borate and 0.3% molybdenum oxide) were subjected to an aging process using 10% H₂O₂.

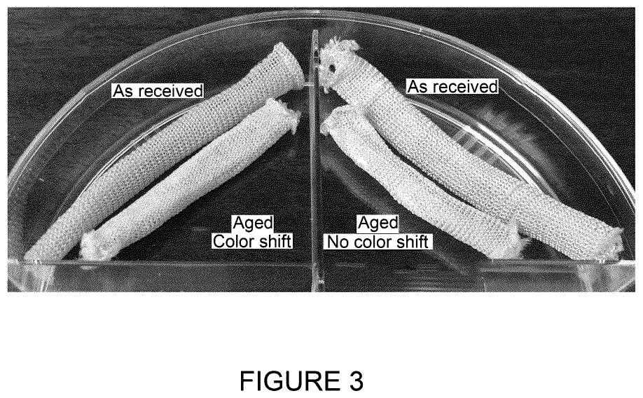

During the experiment, both Sample #1 and Sample #6 were boiled in 10% H₂O₂ for 3 minutes, followed by soaking in 10% H₂O₂ at 37° C. for 3 days. It was observed that both Sample #5 and Sample #12 experienced shrinkage during the boiling process. Before the aging process, FIG. 3 shows that the as-received Sample #5 had a pinkish red color. However, after undergoing the aging process, the color of Sample #5 shifted to pinkish grey. On the other hand, there was no noticeable color shift observed for Sample #12 after the aging process. This suggests that the combining copper oxide with zinc borate and molybdenum oxide contributed to the improved color stability of the PET fabric, as it remained unaffected by the oxidizing agent.

1. An antimicrobial polyurethane foam, comprising:
a polyurethane foam;
a plurality of particles comprising antimicrobial metal compound that release antimicrobial ions upon contact with a fluid in the polyurethane foam; and
a plurality of particles comprising boric compounds embedded in the polyurethane foam.

2. The polyurethane foam of claim 1, wherein the particles comprising water insoluble antimicrobial metal compound that release antimicrobial ions upon contact with a fluid in a concentration from 0.01 wt. % to 10 wt. % of the antimicrobial polyurethane foam.

3. The polyurethane foam of claim 1 or 2, wherein the particles comprising boric compounds in a concentration from 0.05 wt. % to 15 wt. % of the antimicrobial polyurethane foam.

4. A polyurethane foam of claim 1, wherein the particles comprising water insoluble antimicrobial metal compound that release antimicrobial ions upon contact with a fluid are of a size of between 0.2 microns and 20 microns.

5. A polyurethane foam of claim 1, wherein the particles comprising boric compounds are of a size of between 0.2 microns and 20 microns.

6. A polyurethane foam of claim 1, wherein the water insoluble antimicrobial metal compound that release antimicrobial ions upon contact with a fluid are selected from one of copper oxide, copper iodides, copper carbonates, silver oxide, zinc oxide, zinc pyrithione, gold oxide, or combinations thereof.

7. A method of making a polyurethane foam with antibacterial, antifungal and/or antiviral properties comprising:
adding particles comprising an antimicrobial metal compound and particles comprising a boric compound to at least one of an isocyanate and a polyol to form a polyurethane foam precursor;
blending the polyurethane foam precursor with the other of the isocyanate and the polyol; and
providing polymerization conditions for production of polyurethane foam.

8. A method of producing a polyurethane foam, comprising:
treating a plurality of particles comprising an antimicrobial metal compound that release antimicrobial ions upon contact with a fluid to produce a plurality of hydrophobic antimicrobial particles;
mixing a polyol, particles comprising boric compounds, and the plurality of hydrophobic antimicrobial particles to form a polyol slurry; and
mixing the polyol slurry with an isocyanate to form a polyurethane foam.

9. The method of claim 8, wherein the hydrophobic antimicrobial particles are surface modified antimicrobial particles.

10. The method of claim 9, wherein the antimicrobial particles are surface modified by reaction with a fatty acid.

11. The method of claim 10, wherein the fatty acid is stearic acid.

12. The method of claim 11, wherein the fatty acid comprises a hydrophobic tail.

13. The method of claim 9, wherein the antimicrobial particles are surface modified by a reaction oleic acid or palm oil.

14. The method of claim 9, wherein the antimicrobial particles are surface modified by reaction with a saturated fatty acid.

15. The method of claim 8, wherein the polyurethane foam has a density greater than 3.0 lb./sq. ft.

16. The method of claim 8, wherein the isocyanate is at least one of methylene diphenyl diisocyanate and toluene diisocyanate.

17. The method of claim 8, comprising mixing at least one of a polymeric thickener and a surfactant with the polyol and copper oxide.

18. The method of claim 8, comprising reacting the antimicrobial agents surface moieties with a hydrophobic compound.

19. The method of claim 8, wherein the isocyanate is a diphenyl methyl diisocyanate.

20. An antimicrobial polyurethane article, foam, or coating, comprising:
a polyurethane substrate;
a plurality of particles comprising at least one boric compound embedded in the polyurethane substrate; and
a plurality of copper oxide particles embedded in the polyurethane substrate, wherein at least a portion of the copper oxide particles have a hydrophobic coating on their surface.

21. The antimicrobial polyurethane article, foam, or coating of claim 20, wherein the polyurethane comprises reacted monomers derived from at least one of methylene diphenyl diisocyanate and toluene diisocyanate.

22. The antimicrobial polyurethane article, foam, or coating of claim 20, wherein the polyurethane article is a polyurethane foam and has a density greater than 2.0 lb./sq. ft.

23. The antimicrobial polyurethane article, foam, or coating of claim 20, wherein the polyurethane article is a polyurethane foam and has a density greater than 3.0 lb./sq. ft.

24. A polymeric foam, comprising
a polymer foam;
particles comprising water insoluble antimicrobial metal compound that release antimicrobial ions upon contact with a fluid embedded in the polymer foam; and
particles comprising boric compounds embedded in the polymer foam.

24. The polymeric foam of claim 24, wherein the water insoluble antimicrobial metal compound that releases antimicrobial ions upon contact with a fluid in a concentration from 0.01 wt. % to 10 wt. %.

25. The polymeric foam of claim 24, wherein the boric compounds are in a concentration from 0.05 wt. % to 15 wt. %

26. The polymeric foam of claim 24, wherein the water insoluble antimicrobial metal compound that release antimicrobial ions upon contact with a fluid are water insoluble particles of copper oxide and a portion are exposed and protruding from the surface of the foam, wherein said particles release Cu++ when exposed to water or water vapor.

27. The polymeric foam of claim 23, wherein the particles have an average particle size between 0.5 and 2 microns.

28. The polyurethane foam of claim 26, wherein the water insoluble particles of copper oxide are selected from the group consisting of cupric oxide particles, cuprous oxide particles, copper iodide, copper carbonates, and mixtures thereof.

29. A method of making a polyurethane foam with antibacterial, antifungal, and/or antiviral properties comprising adding copper oxide particles to a reaction mixture of an isocyanate and of a polyol, mixing the reaction mixture, and providing polymerization conditions to the reaction mixture.
